(19) United States
(12) Patent Application Publication
(10) Pub. No.: US 2026/0275671 A1
(43) Pub. Date: Sep. 17, 2026

(54) CONSTRUCTION PROCESS FOR PARTIALLY BONDED PRESTRESSED UPLIFT-RESISTANT GLASS FIBER ANCHOR PILES AVOIDING STRESS CONCENTRATION

(71) Applicants: China Energy Conservation Engineering Construction Design and Research Institute Co., Ltd., Chengdu (CN); China National Materials Geological Engineering Exploration Research Institute Co., Ltd., Beijing (CN); Sichuan Pinzheng Testing Technology Co., Ltd., Chengdu (CN); Beijing Building Materials Geological Engineering Co., Ltd., Beijing (CN)

(72) Inventors: Yuhui Zheng, Chengdu (CN); Shiming He, Beijing (CN); Zhijian Wu, Chengdu (CN); Fengyong Wu, Chengdu (CN); Zhilei Hua, Chengdu (CN); Gang Ma, Chengdu (CN); Jiaqi Song, Chengdu (CN); Xiang Liu, Chengdu (CN); Shengqiang Lei, Chengdu (CN); Liping Yu, Chengdu (CN); Haiyang Deng, Chengdu (CN); Weichun Dong, Chengdu (CN); Shengjie Li, Chengdu (CN); Huanbin Liu, Chengdu (CN); Lei Xu, Chengdu (CN); Junxiu Wu, Chengdu (CN); Yingchun Xu, Chengdu (CN); Qiang Wu, Chengdu (CN); Wenzhong Deng, Chengdu (CN); Yating Chu, Chengdu (CN); Ru Zhang, Chengdu (CN); Ping Zhao, Chengdu (CN); Bo Chen, Chengdu (CN); Qi Yue, Chengdu (CN); Tao Zhou, Chengdu (CN); Jiangang Zhang, Chengdu (CN); Hongshuang Cheng, Chengdu (CN); Xi Yuan, Chengdu (CN); Peiwen Liu, Chengdu (CN); Weihui Pan, Chengdu (CN); Liang He, Chengdu (CN); Xiaoliang Gao, Chengdu (CN); Lin Yang, Chengdu (CN); Yunfei Lan, Chengdu (CN); Zuobing Li, Chengdu (CN); Bo Yi, Chengdu (CN); Wenjin Zhang, Beijing (CN); Xiangjun Tang, Beijing (CN); Jia Li, Beijing (CN); Zhijun Wang, Beijing (CN); Daoling Fu, Beijing (CN); Chengqing Si, Beijing (CN); Hui Chen, Beijing (CN); Xinfeng Huang, Beijing (CN); Chenghua Liang, Beijing (CN); Zhongjie Yue, Beijing (CN); Dezhou Liang, Beijing (CN); Wei Hong, Beijing (CN); Cheng Jia, Beijing (CN); Hekun Yu, Beijing (CN); Haining Wang, Beijing (CN); Yu Hao, Beijing (CN); Peng Chen, Beijing (CN); Wei Li, Beijing (CN)

(21) Appl. No.: 19/332,523

(22) Filed: Sep. 18, 2025

(30) Foreign Application Priority Data
Mar. 17, 2025 (CN) 202510309162.1

(51) Int. Cl. E02D 5/36; E02D 5/48; E02D 5/54; E02D 5/58; G06Q 10/0631; G06Q 10/087

(52) U.S. Cl. CPC E02D 5/36; E02D 5/48; E02D 5/54; E02D 5/58; G06Q 10/063112; G06Q 10/06313; G06Q 10/08726; E02D 2250/003; E02D 2250/0046; E02D 2300/0006; E02D 2300/002; E02D 2300/0053

(57) ABSTRACT

A construction process for partially bonded prestressed uplift-resistant glass fiber anchor piles avoiding stress concentration includes the following steps: construction site management, determining anchor pile locations, drilling a borehole using a spiral drilling rig, lowering a pre-fabricated glass fiber rod cage into the borehole after inspection, performing grouting, making adjustments, and repeating the above operations. The construction process adopts a layout that avoids stress concentration, demonstrating its superiority in strata with developed horizontal bedding. Simultaneously, it uses glass fiber material with good corrosion resistance, meeting the requirements for uplift-resistant anchors under corrosive conditions. It employs a partially bonded prestressed design, changing the mechanical characteristic of traditional uplift-resistant anchors from becoming looser when pulled to a wedge-like characteristic of becoming tighter when pulled. For anchors of the same length and diameter, the bearing capacity is significantly improved, potentially by up to 80% according to relevant test data, offering obvious economic advantages.

### CROSS-REFERENCE TO RELATED APPLICATION

This application claims priority to Chinese patent application No. CN 202510309162.1, filed to China National Intellectual Property Administration (CNIPA) on Mar. 17, 2025, which is herein incorporated by reference in its entirety.

### TECHNICAL FIELD

The disclosure relates to the technical field of uplift-resistant anchors, and more particularly to a construction process for partially bonded prestressed uplift-resistant glass fiber anchor piles avoiding stress concentration.

### BACKGROUND

Currently, when designing uplift-resistant anchors, it is common approach to find a relatively good stratum and design all anchors to the same length, believing there is nothing wrong with this approach. In fact, this design is not perfect, it becomes unreasonable when encountering strata with developed horizontal bedding. When a water level rises, buoyancy increases, which may lift the entire horizontal stratum, leading to failure of the anti-flotation design. This requires specific analysis of specific problems, targeted design to improve drawbacks of current conventional designs, striving to avoid stress concentration, and elevating anti-flotation design to a new level.

In a corrosive environment, corrosion-resistant design is also required for the anchors. Besides being wrapped in cement grout or mortar to prevent corrosion, an inner rod of a anchorage section usually uses a corrugated pipe as an outer casing in severely corrosive environments, with voids inside the pipe filled with epoxy resin or cement grout. A thickness of a protective layer around the casing should not be less than 10 millimeters (mm). In the related art, there are patents such as a patent titled “Concrete pole body compound anchor rod and construction method thereof” (CN201510360640.8, with a publication number of CN104929117A), and a patent “Compound stock of concrete pole body” (CN201520446623.1, with a publication number of CN204959745U), which includes: a concrete pole body, a reinforcement tube, grout, tendons and a positioning guide device; and an upper end uses a pressed anchor or a wedge-type anchor. Its construction method involves first pressure-grouting to form a plain concrete pile (also referred to as unreinforced concrete pile), then implanting a steel pipe (reinforcement tube), subsequently inserting steel strands, injecting cement grout, using the steel pipe to protect the internal steel strands, with an external thick plain concrete protective layer. It appears to have double-layer corrosion protection, but detailed analysis reveals that because long auger pressure-grouted plain concrete piles are used, typically with a diameter not less than 400 mm, which is larger than conventional anchors (150-200 mm), a side friction resistance is relatively great, and the uplift resistance borne by a single anchor pile is correspondingly higher, reducing the total number of anchors. Under a condition of high uplift bearing capacity of a single anchor pile, the steel pipe is fully bonded, and its mechanical behavior is no different from that of ordinary uplift anchor piles, which will cause cracking of the concrete around the steel pipe. The design itself dictates the characteristic that the concrete surrounding the steel pipe inevitably cracks due to the high uplift capacity of a single anchor pile, leading to failure of a first layer of corrosion protection. A second layer of corrosion protection is the steel pipe, whose corrosion resistance is extremely limited. This results in seemingly double protection but actually very limited effectiveness. It can even be said that this is a design with inherent defects.

Partially bonded prestressing technology is relatively mature whether used for steel strands or steel bars. It can quickly transfer buoyancy or uplift force to a lower part of the pile or anchor, forming a wedge effect in the lower part during uplift, making it tighter as it is pulled. Simply changing a cage structure alters its mechanical behavior, bringing the benefit of significantly increased bearing capacity for the same pile length or anchor length, while also allowing design according to first-level crack control. It is a good technology whose advantages should be further utilized.

Glass fiber rods or tubes offer outstanding advantages: high strength, especially high tensile strength, light weight, easy transportation and handling, and good corrosion resistance, which can be summarized as high strength, light weight, and corrosion resistance. Their weight is only ¼ that of the steel bar of the same volume, tensile strength is 20% higher than the steel bar of the same specification, and thermal expansion coefficient is closer to that of cement compared to steel, resulting in stronger bonding grip force (also referred to as bond and anchorage force) with concrete, mortar, cement grout, etc. The processing performance is also very great. These properties are exactly what the uplift-resistant anchors need in the corrosive environment.

It should be noted that the above content belongs to the technical knowledge of the inventor and does not necessarily constitute the related art.

### SUMMARY

A purpose of the disclosure is to address shortcomings of the related art by providing a construction process for partially bonded prestressed uplift-resistant glass fiber anchor piles avoiding stress concentration, to solve problems raised in the background.

To achieve the above purpose, the disclosure provides the following technical solution. Specifically, a construction process for partially bonded prestressed uplift-resistant glass fiber anchor piles avoiding stress concentration, including the following steps:
step 1: implementing site management measures, including balancing site layout, balancing personnel allocation, balancing material storage, and ensuring unimpeded communication;
step 2: performing surveying, layout, and determination of anchor pile locations according to design drawings, with specific steps as follows: drilling holes at designated anchor positions using steel bars, marking positions of the holes with lime, and inserting wooden sticks for additional identification when necessary, where all anchor pile locations for a building unit are laid out in a single operation and must be jointly inspected and approved by supervisory and construction parties before proceeding to subsequent operations;
step 3: drilling a borehole using a long spiral drilling rig, advancing to a designed depth under a condition where hole collapse does not occur in stratum, and then withdrawing the long spiral drilling rig from the borehole;
step 4: inspecting a diameter, a depth, a verticality of the borehole, and a thickness of loose sediment at a bottom of the borehole, and upon meeting requirements, lowering a pre-fabricated glass fiber rod cage into the borehole;
step 5: injecting cement grout through a primary grouting pipe up to a designed elevation, and injecting the cement grout through a secondary grouting pipe to achieve a designed grout volume when necessary, so as to complete a construction of an anchor pile;
   where the cement grout is prepared as follows: selecting raw materials of the cement grout, repeatedly determining a mix ratio, mixing the raw materials in a mixer to obtain mixed raw materials, filtering the mixed raw materials through a fixed screen to obtain the cement grout, and pumping the cement grout using a grout pump;
step 6: moving the long spiral drilling rig, readjusting leveling and verticality of the long spiral drilling rig, constructing a next anchor pile using the long spiral drilling rig; and
step 7: after the construction of the anchor pile is complete and the anchor pile is cured to a required age, conducting load testing, and upon passing inspection, tensioning and locking the anchor pile by tightening a nut to a designed torque value;
   where a locking device is selectively positioned at a top of the anchor pile with an elongation portion embedded into a base slab, or alternatively positioned at a reserved position in an upper half portion of the base slab, and after locking, a reserved cavity is filled with waterproof concrete;
   where under a target stress condition, a certain amount of covering soil is designed above the base slab, the locking device is placed above the base slab, and the covering soil is proceeded directly after locking.

In some embodiment, the balancing site layout of the implementing site management measures of step 1 includes steps as follows:
planning reasonable construction zones, storage areas, office spaces, and living quarters based on construction drawings and project requirements to ensure unobstructed traffic therebetween;
establishing safe and accessible entry and exit routes to ensure smooth movement of personnel and materials; and
providing clear signage and directional markers to assist construction personnel in quickly understanding the site layout and enabling rapid positioning of equipment including the long spiral drilling rig during construction;

The balancing personnel allocation of the implementing site management measures of step 1 includes steps as follows:
defining responsibilities and tasks for each work position based on construction requirements and construction schedule;
rationally assigning a number of workers according to different types of work and construction sequences to ensure sufficient manpower in a work region to maintain the construction schedule;
providing training for all construction personnel to ensure all construction personnel master necessary operational procedures; and
dynamically adjusting the personnel allocation based on the construction schedule and field conditions to avoid imbalances in human resource distribution;

The balancing material storage of the implementing site management measures of step 1 includes steps as follows:
developing a detailed material procurement and supply plan based on the construction schedule and material demands of the construction sequences;
pre-stocking essential materials to prevent delays due to shortages; and
regularly inspecting material inventory and promptly replenishing any shortages or damaged items.

In some embodiments, the ensuring unimpeded communication of the implementing site management measures of step 1 includes steps as follows:
enabling effective and rapid communication among all on-site managers and the construction personnel via landline telephones, walkie-talkies, or mobile phones; and
establishing clear information transmission channels to ensure that all decisions and instructions during construction are rapidly conveyed.

In some embodiments, a diameter of a glass fiber rod of the pre-fabricated glass fiber rod cage in step 4 is controlled in a range of 20-50 millimeters (mm); a diameter of the holes of anchors in step 2 is controlled in a range of 150-200 mm, and an arrangement of the anchors is specifically as follows: in a first row, the anchors at odd numbers 1, 3, 5, 7, 9 are designed as long, the anchors at even numbers 2, 4, 6, 8, 10 are designed as short; in a second row, the anchors are spaced apart corresponding to the first row, and a third row and a fourth row follow this pattern accordingly.

In some embodiments, in step 3, before the positioning the long spiral drilling rig, a site surface is leveled and compacted to meet construction verticality requirements; after the long spiral drilling rig is positioned at a specified location, under guidance of technical personnel, angles of a mast and a drill pipe are adjusted, and hole positioning is performed using a cross-centering method.

In some embodiments, a lower part of the pre-fabricated glass fiber rod cage has a threaded structure bonding with the cement grout; an upper part of the pre-fabricated glass fiber rod cage is coated with grease and externally wrapped with a plastic sleeve, and both ends of the plastic sleeve are tied with binding wires to prevent the cement grout from entering, thereby maintaining an unbonded section.

The pre-fabricated glass fiber rod cage has a structure consistent with a conventional steel rebar cage and is equipped with a centralizer bracket every 1.5-2 meters; and the centralizer bracket is made of corrosion-resistant plastic material.

In some embodiments, in step 5, the primary grouting pipe and the secondary grouting pipe are located within reserved inner cavities respectively; the secondary grouting pipe is made of glass fiber and left in place without retrieval, and optionally used for fracture grouting when necessary.

In some embodiments, during operation of the drilling a borehole using a long spiral drilling rig in step 3, when the hole collapse occurs in the stratum, the construction process includes:
(1) conducting initial batch inspection and slump test at a collapsed location;
(2) transporting concrete to a site pump and connecting a grouting hose of the long spiral drilling rig to the site pump;
(3) opening a valve at a bottom of the long spiral drilling rig by pressure-grouting concrete, then simultaneously grouting and raising a pile pipe to the designed elevation;
(4) withdrawing the long spiral drilling rig, inserting the pre-fabricated glass fiber rod cage into the concrete to the designed depth, and lifting a vibratory hammer clear of an opening of the anchor pile; and
(5) moving the long spiral drilling rig, readjusting the leveling and the verticality of the long spiral drilling rig, constructing the next anchor pile using the long spiral drilling rig.

Compared with the related art, the disclosure provides the construction process for partially bonded prestressed uplift-resistant glass fiber anchor piles avoiding stress concentration, which has beneficial effects as follows.

In the disclosure, the construction process for partially bonded prestressed uplift-resistant glass fiber anchor piles avoiding stress concentration adopts a layout that avoids stress concentration, demonstrating its superiority in strata with developed horizontal bedding. Simultaneously, it uses glass fiber material with good corrosion resistance, meeting the requirements for uplift-resistant anchors under corrosive conditions. It employs a partially bonded prestressed design, changing the mechanical characteristic of traditional uplift-resistant anchors from becoming looser when pulled to a wedge-like characteristic of becoming tighter when pulled. For anchors of the same length and diameter, the bearing capacity is significantly improved, potentially by up to 80% according to relevant test data, offering obvious economic advantages. Furthermore, due to the adoption of the anchor pile design concept, the concept of a pile can be used during acceptance, greatly reducing the number of tests required, saving both testing costs and time, and improving efficiency.

For the same bearing capacity, fewer anchor piles can be arranged, or for the same number of piles, the pile length or diameter can be reduced. Not only does this save on concrete, mortar, and labor costs, but it also improves efficiency and construction civilization. The savings bring about by the increase in bearing capacity alone can account for more than 20% of the total cost. The key is to avoid concentrated loading and extend the service life of the superstructure. The economic benefits are significant, and the social and environmental benefits are evident.

### BRIEF DESCRIPTION OF DRAWINGS

The drawings described herein are provided to provide further understanding of the disclosure and constitute a part of the disclosure. Embodiments illustrated in the disclosure and their descriptions are used to explain the disclosure and do not constitute an undue limitation of the disclosure.

FIG. 1 is a flowchart of construction for partially bonded prestressed uplift-resistant glass fiber anchor piles avoiding stress concentration under a non-collapsing hole condition according to the disclosure.

FIG. 2 is a flowchart of construction for the partially bonded prestressed uplift-resistant glass fiber anchor piles avoiding stress concentration under a stratum collapse condition according to the disclosure.

FIG. 3 is a schematic plan view of an anchor pile arrangement state according to the disclosure.

FIG. 4 is a schematic sectional view of anchor piles according to the disclosure.

FIG. 5 is a schematic diagram of prestress applied at an end of the anchor pile according to the disclosure.

FIG. 6 is a schematic diagram of the prestress applied in a reserved small pit in an upper part of a base slab according to the disclosure.

FIG. 7 is a schematic diagram of the prestress applied on an upper surface of the base slab according to the disclosure.

### DETAILED DESCRIPTION OF EMBODIMENTS

Technical solutions in the embodiments of the disclosure will be clearly and completely described below with reference to the accompanying drawings in the embodiments of the disclosure. Apparently, the described embodiments are only a part of the embodiments of the disclosure, not all of them. Based on the embodiments of the disclosure, all other embodiments obtained by those skilled in the art without creative work shall fall within the protection scope of the disclosure.

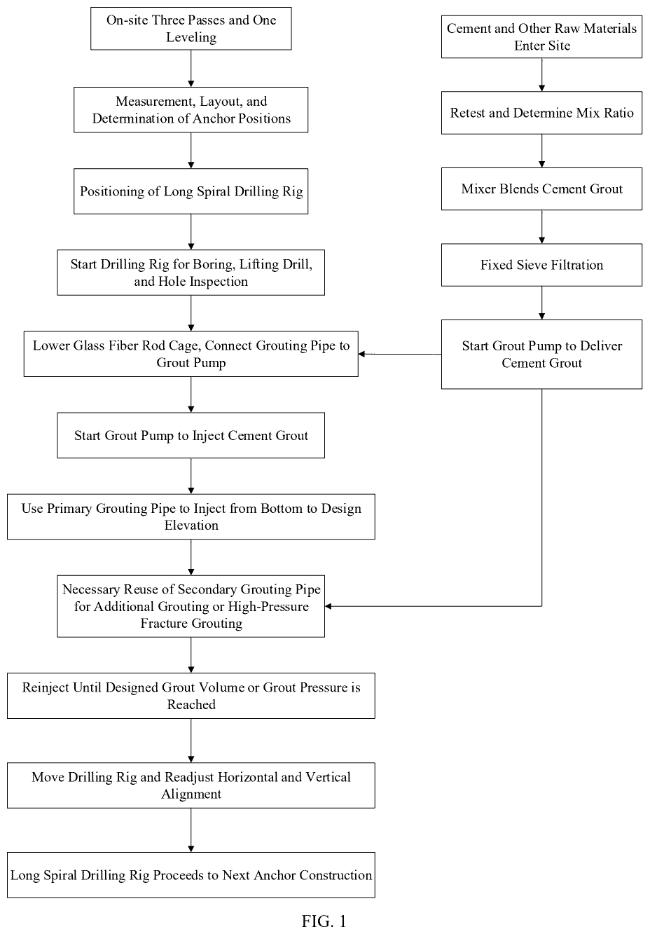

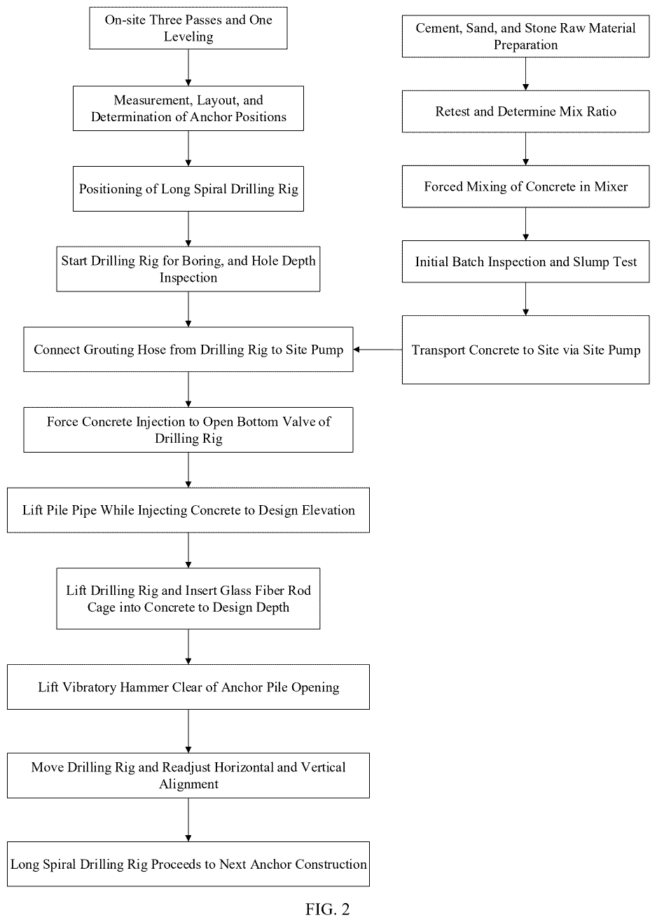

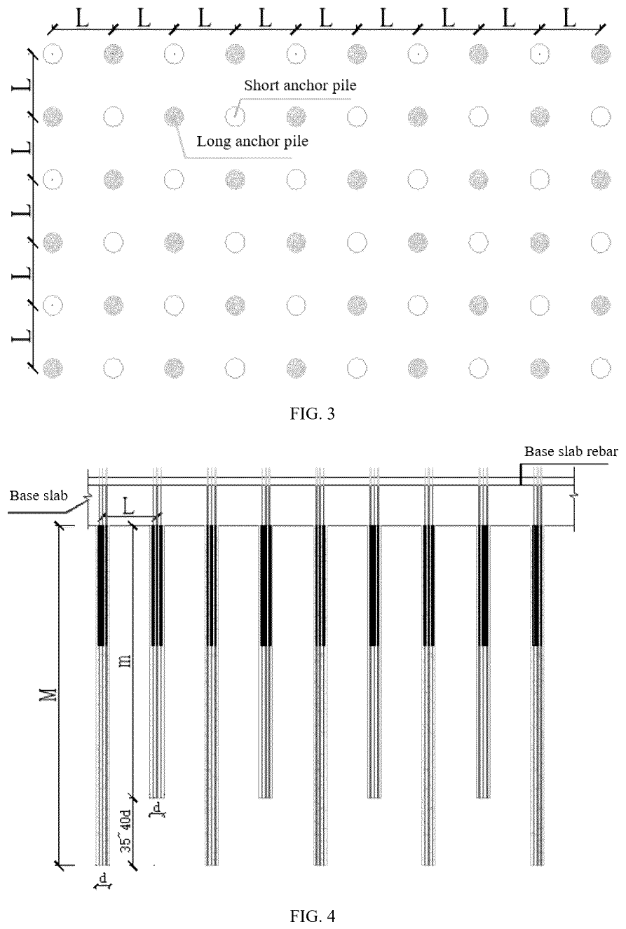

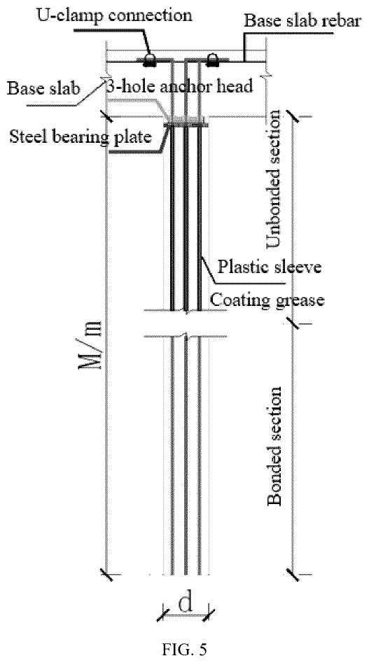

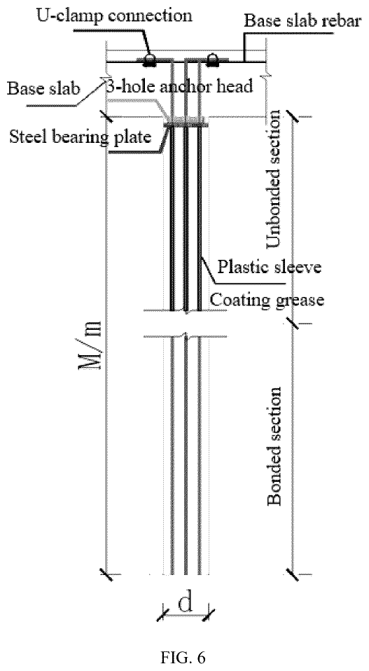

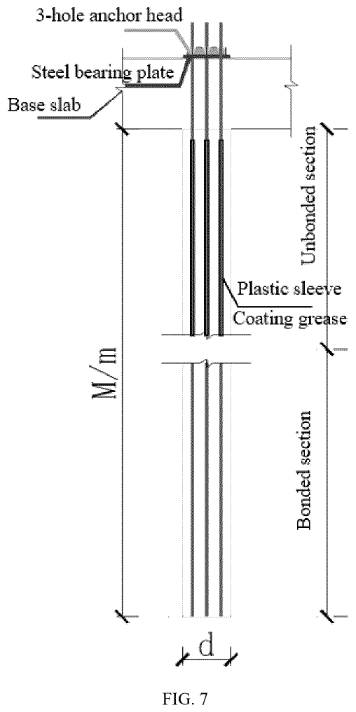

Referring to FIG. 1 to FIG. 7, the embodiments of the disclosure are described below.

Embodiment 1: a construction process for partially bonded prestressed uplift-resistant glass fiber anchor piles avoiding stress concentration includes the following steps.

Step 1: implementing site management measures, including balancing site layout, balancing personnel allocation, balancing material storage, and ensuring unimpeded communication.

The implementation of the balancing site layout of the implementing site management measures is as follows:
planning reasonable construction zones, storage areas, office spaces, and living quarters based on construction drawings and project requirements to ensure unobstructed traffic therebetween;
establishing safe and accessible entry and exit routes to ensure smooth movement of personnel and materials; and
providing clear signage and directional markers to assist construction personnel in quickly understanding the site layout and enabling rapid positioning of equipment including the long spiral drilling rig during construction.

The implementation of the balancing personnel allocation of the implementing site management measures is as follows:
defining responsibilities and tasks for each work position based on construction requirements and construction schedule;
rationally assigning a number of workers according to different types of work and construction sequences to ensure sufficient manpower in a work region to maintain the construction schedule;
providing training for all construction personnel to ensure all construction personnel master necessary operational procedures; and
dynamically adjusting the personnel allocation based on the construction schedule and field conditions to avoid imbalances in human resource distribution.

The implementation of the balancing material storage of the implementing site management measures is as follows:
developing a detailed material procurement and supply plan based on the construction schedule and material demands of the construction sequences;
pre-stocking essential materials to prevent delays due to shortages; and
regularly inspecting material inventory and promptly replenishing any shortages or damaged items.

The implementation of the ensuring unimpeded communication of the implementing site management measures is as follows:
enabling effective and rapid communication among all on-site managers and the construction personnel via landline telephones, walkie-talkies, or mobile phones; and
establishing clear information transmission channels to ensure that all decisions and instructions during construction are rapidly conveyed.

Step 2: performing surveying, layout, and determination of anchor pile locations according to design drawings, with specific steps as follows: drilling holes at designated anchor positions using steel bars, marking positions of the holes with lime, and inserting wooden sticks for additional identification when necessary, where all anchor pile locations for a building unit are laid out in a single operation and must be jointly inspected and approved by supervisory and construction parties before proceeding to subsequent operations.

A diameter of a glass fiber rod of the pre-fabricated glass fiber rod cage in step 4 is controlled in a range of 20-50 millimeters (mm); a diameter of the holes of anchors in step 2 is controlled in a range of 150-200 mm, and an arrangement of the anchors is specifically as follows: in a first row, the anchors at odd numbers 1, 3, 5, 7, 9 are designed as long, the anchors at even numbers 2, 4, 6, 8, 10 are designed as short; in a second row, the anchors are spaced apart corresponding to the first row, and a third row and a fourth row follow this pattern accordingly.

Step 3: drilling a borehole using a long spiral drilling rig, advancing to a designed depth under a condition where hole collapse does not occur in stratum, and then withdrawing the long spiral drilling rig from the borehole.

Before the positioning the long spiral drilling rig, a site surface is leveled and compacted to meet construction verticality requirements; after the long spiral drilling rig is positioned at a specified location, under guidance of technical personnel, angles of a mast and a drill pipe are adjusted, and hole positioning is performed using a cross-centering method.

Step 4: inspecting a diameter, a depth, a verticality of the borehole, and a thickness of loose sediment at a bottom of the borehole, and upon meeting requirements, lowering a pre-fabricated glass fiber rod cage into the borehole.

A lower part of the pre-fabricated glass fiber rod cage has a threaded structure bonding with the cement grout; an upper part of the pre-fabricated glass fiber rod cage is coated with grease and externally wrapped with a plastic sleeve, and both ends of the plastic sleeve are tied with binding wires to prevent the cement grout from entering, thereby maintaining an unbonded section.

The pre-fabricated glass fiber rod cage has a structure consistent with a conventional steel rebar cage and is equipped with a centralizer bracket every 1.5-2 meters; and the centralizer bracket is made of corrosion-resistant plastic material.

Step 5: injecting cement grout through a primary grouting pipe up to a designed elevation, and injecting the cement grout through a secondary grouting pipe to achieve a designed grout volume when necessary, so as to complete a construction of an anchor pile.

The cement grout is prepared as follows: selecting raw materials of the cement grout, repeatedly determining a mix ratio, mixing the raw materials in a mixer to obtain mixed raw materials, filtering the mixed raw materials through a fixed screen to obtain the cement grout, and pumping the cement grout using a grout pump.

The primary grouting pipe and the secondary grouting pipe are located within reserved inner cavities respectively; the secondary grouting pipe is made of glass fiber and left in place without retrieval, and optionally used for fracture grouting when necessary

Step 6: moving the long spiral drilling rig, readjusting leveling and verticality of the long spiral drilling rig, constructing a next anchor pile using the long spiral drilling rig.

Step 7: after the construction of the anchor pile is complete and the anchor pile is cured to a required age, conducting load testing, and upon passing inspection, tensioning and locking the anchor pile by tightening a nut to a designed torque value.

A locking device is selectively positioned at a top of the anchor pile with an elongation portion embedded into a base slab, or alternatively positioned at a reserved position in an upper half portion of the base slab, and after locking, a reserved cavity is filled with waterproof concrete.

Under a target stress condition, a certain amount of covering soil is designed above the base slab, the locking device is placed above the base slab, and the covering soil is proceeded directly after locking.

Embodiment 2: a construction process for partially bonded prestressed uplift-resistant glass fiber anchor piles avoiding stress concentration includes the following steps.

Step 1: implementing site management measures, including balancing site layout, balancing personnel allocation, balancing material storage, and ensuring unimpeded communication.

The implementation of the balancing site layout of the implementing site management measures is as follows:
planning reasonable construction zones, storage areas, office spaces, and living quarters based on construction drawings and project requirements to ensure unobstructed traffic therebetween;
establishing safe and accessible entry and exit routes to ensure smooth movement of personnel and materials; and
providing clear signage and directional markers to assist construction personnel in quickly understanding the site layout and enabling rapid positioning of equipment including the long spiral drilling rig during construction.

The implementation of the balancing personnel allocation of the implementing site management measures is as follows:
defining responsibilities and tasks for each work position based on construction requirements and construction schedule;
rationally assigning a number of workers according to different types of work and construction sequences to ensure sufficient manpower in a work region to maintain the construction schedule;
providing training for all construction personnel to ensure all construction personnel master necessary operational procedures; and
dynamically adjusting the personnel allocation based on the construction schedule and field conditions to avoid imbalances in human resource distribution.

The implementation of the balancing material storage of the implementing site management measures is as follows:
developing a detailed material procurement and supply plan based on the construction schedule and material demands of the construction sequences;
pre-stocking essential materials to prevent delays due to shortages; and
regularly inspecting material inventory and promptly replenishing any shortages or damaged items.

The implementation of the ensuring unimpeded communication of the implementing site management measures is as follows:
enabling effective and rapid communication among all on-site managers and the construction personnel via landline telephones, walkie-talkies, or mobile phones; and
establishing clear information transmission channels to ensure that all decisions and instructions during construction are rapidly conveyed.

Step 2: performing surveying, layout, and determination of anchor pile locations according to design drawings, with specific steps as follows: drilling holes at designated anchor positions using steel bars, marking positions of the holes with lime, and inserting wooden sticks for additional identification when necessary, where all anchor pile locations for a building unit are laid out in a single operation and must be jointly inspected and approved by supervisory and construction parties before proceeding to subsequent operations.

A diameter of a glass fiber rod of the pre-fabricated glass fiber rod cage in step 4 is controlled in a range of 20-50 mm; a diameter of the holes of anchors in step 2 is controlled in a range of 150-200 mm, and an arrangement of the anchors is specifically as follows: in a first row, the anchors at odd numbers 1, 3, 5, 7, 9 are designed as long, the anchors at even numbers 2, 4, 6, 8, 10 are designed as short; in a second row, the anchors are spaced apart corresponding to the first row, and a third row and a fourth row follow this pattern accordingly.

Step 3: drilling a borehole using a long spiral drilling rig, and conducting initial batch inspection and slump test at a collapsed location.

Before the positioning the long spiral drilling rig, a site surface is leveled and compacted to meet construction verticality requirements; after the long spiral drilling rig is positioned at a specified location, under guidance of technical personnel, angles of a mast and a drill pipe are adjusted, and hole positioning is performed using a cross-centering method.

The concrete is transported to a site pump and a grouting hose of the long spiral drilling rig is connected to the site pump.

A valve at the bottom of the long spiral drilling rig is opened by pressure-grouting concrete, and then grouting and raising of the pile pipe are performed simultaneously to the designed elevation.

The long spiral drilling rig is withdrawn, the pre-fabricated glass fiber rod cage is inserted into the concrete to the designed depth, and a vibratory hammer is lifted clear of an opening of the anchor pile.

A lower part of the pre-fabricated glass fiber rod cage has a threaded structure bonding with the cement grout; an upper part of the pre-fabricated glass fiber rod cage is coated with grease and externally wrapped with a plastic sleeve, and both ends of the plastic sleeve are tied with binding wires to prevent the cement grout from entering, thereby maintaining an unbonded section.

The pre-fabricated glass fiber rod cage has a structure consistent with a conventional steel rebar cage and is equipped with a centralizer bracket every 1.5-2 meters; and the centralizer bracket is made of corrosion-resistant plastic material.

The long spiral drilling rig is moved, the leveling and the verticality of the long spiral drilling rig are readjusted, and the next anchor pile is constructed using the long spiral drilling rig.

Various embodiments in the disclosure are described in a progressive manner, with identical or similar parts between embodiments referring to each other. Each embodiment focuses on describing its differences from other embodiments. Particularly, for system embodiments, since they are basically similar to method embodiments, the description is relatively simple; relevant parts can be referred to the descriptions in the method embodiments.

Finally, it should be noted that the above embodiments are only illustrated embodiments of the disclosure and are not intended to limit the disclosure. Although the disclosure has been described in detail with reference to the foregoing embodiments, those skilled in the art can still modify the technical solutions described in the foregoing embodiments or equivalently replace some of the technical features. Any modifications, equivalent substitutions, improvements, etc., made within the spirit and principles of the disclosure shall be included within the protection scope of the disclosure.

What is claimed is:

1. A construction process for partially bonded prestressed uplift-resistant glass fiber anchor piles avoiding stress concentration, comprising the following steps:
step 1: implementing site management measures, comprising balancing site layout, balancing personnel allocation, balancing material storage, and ensuring unimpeded communication;
step 2: performing surveying, layout, and determination of anchor pile locations according to design drawings, with specific steps as follows: drilling holes at designated anchor positions using steel bars, marking positions of the holes with lime, and inserting wooden sticks for additional identification when necessary, wherein all anchor pile locations for a building unit are laid out in a single operation and must be jointly inspected and approved by supervisory and construction parties before proceeding to subsequent operations;
step 3: drilling a borehole using a spiral drilling rig, advancing to a designed depth under a condition where hole collapse does not occur in stratum, and then withdrawing the spiral drilling rig from the borehole;
step 4: inspecting a diameter, a depth, a verticality of the borehole, and a thickness of loose sediment at a bottom of the borehole, and upon meeting requirements, lowering a pre-fabricated glass fiber rod cage into the borehole;
step 5: injecting cement grout through a primary grouting pipe up to a designed elevation, and injecting the cement grout through a secondary grouting pipe to achieve a designed grout volume when necessary, so as to complete a construction of an anchor pile;
wherein the cement grout is prepared as follows: selecting raw materials of the cement grout, repeatedly determining a mix ratio, mixing the raw materials in a mixer to obtain mixed raw materials, filtering the mixed raw materials through a fixed screen to obtain the cement grout, and pumping the cement grout using a grout pump;
step 6: moving the spiral drilling rig, readjusting leveling and verticality of the spiral drilling rig, constructing a next anchor pile using the spiral drilling rig; and
step 7: after the construction of the anchor pile is complete and the anchor pile is cured to a required age, conducting load testing, and upon passing inspection, tensioning and locking the anchor pile by tightening a nut to a designed torque value;
wherein a locking device is selectively positioned at a top of the anchor pile with an elongation portion embedded into a base slab, or alternatively positioned at a reserved position in an upper half portion of the base slab, and after locking, a reserved cavity is filled with waterproof concrete;
wherein under a target stress condition, a certain amount of covering soil is designed above the base slab, the locking device is placed above the base slab, and the covering soil is proceeded directly after locking.

2. The construction process as claimed in claim 1, wherein the balancing site layout of the implementing site management measures of step 1 comprises steps as follows:
planning construction zones, storage areas, office spaces, and living quarters based on construction drawings and project requirements to ensure unobstructed traffic therebetween;
establishing entry and exit routes to ensure smooth movement of personnel and materials; and
providing signage and directional markers to assist construction personnel in understanding the site layout and enabling positioning of equipment comprising the spiral drilling rig during construction;
wherein the balancing personnel allocation of the implementing site management measures of step 1 comprises steps as follows:
defining responsibilities and tasks for each work position based on construction requirements and construction schedule;
assigning a number of workers according to different types of work and construction sequences to ensure sufficient manpower in a work region to maintain the construction schedule;
providing training for all construction personnel to ensure all construction personnel master necessary operational procedures; and
dynamically adjusting the personnel allocation based on the construction schedule and field conditions to avoid imbalances in human resource distribution;
wherein the balancing material storage of the implementing site management measures of step 1 comprises steps as follows:
developing a detailed material procurement and supply plan based on the construction schedule and material demands of the construction sequences;
pre-stocking essential materials to prevent delays due to shortages; and
regularly inspecting material inventory and promptly replenishing any shortages or damaged items.

3. The construction process as claimed in claim 1, wherein the ensuring unimpeded communication of the implementing site management measures of step 1 comprises steps as follows:
enabling communication among all on-site managers and construction personnel via landline telephones, walkie-talkies, or mobile phones; and
establishing information transmission channels to ensure that all decisions and instructions during construction are conveyed.

4. The construction process as claimed in claim 1, wherein a diameter of a glass fiber rod of the pre-fabricated glass fiber rod cage in step 4 is controlled in a range of 20-50 millimeters (mm); a diameter of the holes of anchors in step 2 is controlled in a range of 150-200 mm, and an arrangement of the anchors is specifically as follows: in a first row, the anchors at odd numbers 1, 3, 5, 7, 9 are designed as long, the anchors at even numbers 2, 4, 6, 8, 10 are designed as short; in a second row, the anchors are spaced apart corresponding to the first row, and a third row and a fourth row follow this pattern accordingly.

5. The construction process as claimed in claim 1, wherein in step 3, before the positioning the spiral drilling rig, a site surface is leveled and compacted to meet construction verticality requirements; after the spiral drilling rig is positioned at a specified location, under guidance of technical personnel, angles of a mast and a drill pipe are adjusted, and hole positioning is performed using a cross-centering method.

6. The construction process as claimed in claim 1, wherein a lower part of the pre-fabricated glass fiber rod cage has a threaded structure bonding with the cement grout; an upper part of the pre-fabricated glass fiber rod cage is coated with grease and externally wrapped with a plastic sleeve, and both ends of the plastic sleeve are tied with binding wires to prevent the cement grout from entering, thereby maintaining an unbonded section; and
wherein the pre-fabricated glass fiber rod cage has a structure consistent with a conventional steel rebar cage and is equipped with a centralizer bracket every 1.5-2 meters; and
the centralizer bracket is made of corrosion-resistant plastic material.

7. The construction process as claimed in claim 1, wherein in step 5, the primary grouting pipe and the secondary grouting pipe are located within reserved inner cavities respectively; the secondary grouting pipe is made of glass fiber and left in place without retrieval, and optionally used for fracture grouting when necessary.

8. The construction process as claimed in claim 1, wherein during operation of the drilling a borehole using a spiral drilling rig in step 3, when the hole collapse occurs in the stratum, the construction process comprises:
(1) conducting initial batch inspection and slump test at a collapsed location;
(2) transporting concrete to a site pump and connecting a grouting hose of the spiral drilling rig to the site pump;
(3) opening a valve at a bottom of the spiral drilling rig by pressure-grouting concrete, then simultaneously grouting and raising a pile pipe to the designed elevation;
(4) withdrawing the spiral drilling rig, inserting the pre-fabricated glass fiber rod cage into the concrete to the designed depth, and lifting a vibratory hammer clear of an opening of the anchor pile; and
(5) moving the spiral drilling rig, readjusting the leveling and the verticality of the spiral drilling rig, constructing the next anchor pile using the spiral drilling rig.
